(19) United States
(12) Patent Application Publication
(10) Pub. No.: US 2023/0331108 A1
(43) Pub. Date: Oct. 19, 2023

(54) Miniature EV Battery Charger and Range Extender

(71) Applicant: Kenneth Stephen Bailey, Boca Raton, FL (US)

(72) Inventor: Kenneth Stephen Bailey, Boca Raton, FL (US)

(21) Appl. No.: 18/070,345

(22) Filed: Nov. 28, 2022

Related U.S. Application Data
(60) Provisional application No. 63/339,472, filed on May 8, 2022.

(51) Int. Cl. B60L 53/54; H02J 7/00; B60L 53/57

(52) U.S. Cl. CPC B60L 53/54; H02J 7/0042; B60L 53/57; H02J 15/008

(57) ABSTRACT

There are currently approximately 16 Million EV's in the World today of various makes, models, and types. Regardless, each type requires periodic charging of the batteries and the number of batteries on board determines the vehicle range. These 16 million cars consume roughly 30 Terawatt-Hours (TWh) of electricity per year, the equivalent of all the electricity generated in the country of Ireland. A hydrogen powered battery charger embedded in the vehicle can create additional green energy to extend the range of the vehicle for a small cost of hydrogen, and can be added after market regardless of the vehicle brand or model, since there are no engines, transmissions, or rear drive assemblies are as found in typical fossil fuel vehicles today. The generator is a PEM type module connected to a electric alternator or DC generator which is housed within the vehicle in a small footprint. Such a unit can have an expected life cycle of some 20 years or more.

### BACKGROUND OF THE INVENTION

This invention claims priority from Provisional Application 63/339,472 filed May 8, 2022. Portable battery chargers have become common place in the world since the invention of Lithium-Ion batteries in the late 1970's by M. Stanley Whittingham, for which he shared the Nobel Prize in 2019, in chemistry. These batteries power, mostly portable devices in use today, such as your cell phone, laptop, tablet, camera, wrist watch, and even electric vehicles (EV's). Inventor, Elon Musk proliferated the TESLA car which became popular in 2008 (Model S) for those concerned about fossil fuels causing global warming, climate change, and poor health due to air pollution of all kinds. Since the inception of the TESLA vehicle which presently has sold about 2 million vehicles thus far, other manufacturers such as Hyundai, Porsche, Audi, Nissan, Mazda, Honda, BMW, KIA, Volkswagen, Ford, and Chevy, have begun mass production of their own version of EV.

In California where TESLA was first introduced, the number of charging stations has risen in the past two years significantly to about 73,000 stations and a recent report shows they will require about 1.2 Million by 2030 to meet the public demand just in the State of California of approximately 7.5 million passenger cars by that time.

Worldwide there are expected to be 145 Million EV's by 2030, and increase to 2.21 Billion vehicles by 2050. In that time both Federal and Municipal Governments in the United States are promoting EV sales by subsidizing the market growth in a number of ways. There are also consumer tax incentives, home charging stations, rapid growth in the deployment of roadside charging stations, and Billions of dollars in cash for entrepreneurs who want to provide services and support for EV's in the world.

Almost all public and private battery charging stations require some amount of electric power to operate, such as solar, the local power grid, or natural gas (which is also a fossil fuel).

In the past ten years I/C chip manufacturers such as Texas Instruments whose manufactured IC's are found in most portable devices today, had decided to focus their attention to reducing battery consumption in portable devices they manufacture by making the internal components less power dependent and thereby extending the useful daily life of the LI-ION batteries that power any device.

It is logical to assume that any means to extend the battery life in an Electric Vehicle by 2030, and 2050 would be advantageous to the owner or consumer of most EV's and reduce the demand for roadside EV charging stations.

Specifications

This invention relates generally to the charging of li-ion batteries in Electric Vehicles (EV's) utilizing hydrogen gas or liquid, as the energy source to primarily extend the useful range of any and all EV's.

This system comprises: A hydrogen storage tank, a PEM type miniature fuel cell, a DC to AC converter, a storage capacitor, system monitor attached to the vehicle dash board, an overload protection circuit, and a flame proof enclosure housing. This system requires little or no maintenance and has a five year factory warranty. The system runs on semi-conductor grade hydrogen of no less than 98.5% purity overall.

### A BRIEF DESCRIPTION OF THE DRAWINGS

FIG. 1 depicts the overall end to end system components as might be found in the preferred embodiment of the present invention, for example.

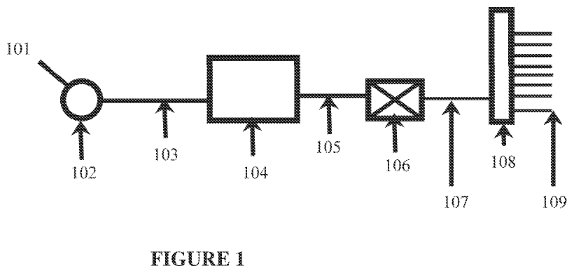

FIG. 2 depicts the vehicle dashboard details as might be found in the preferred embodiment of the present invention, for example.

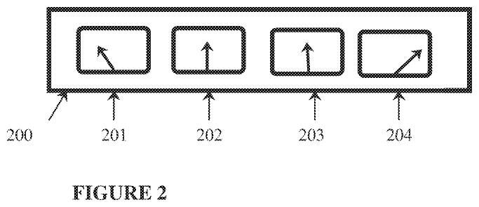

FIG. 3 depicts the mounting of the system in a subject EV as might be found in the preferred embodiment of the present invention, for example.

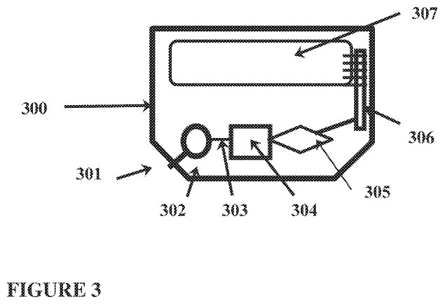

1. An aftermarket or factory installed Electric Vehicle (EV) battery charger that is embedded within the EV vehicle powered by hydrogen gas stored within the vehicle and periodically refueled with hydrogen gas from time to time at a hydrogen refueling station on an as needed basis to extend the vehicle range by up to 25% or more overall.

2. Claim 1 further comprising that the charging system may be encapsulated in a compact container with carry handles that may be removed and reinstalled by the user from time to time for remote charging of an Electric Vehicle in someone's garage, a hotel, or at a remote location wherein the invention may be used to create electricity for all types of needs and usages as required by the user.

3. Claim 1 and claim 2 further comprising that the charging system might be used to provide electricity on a limited emergency basis to power a motor home, camper, outdoor venue lighting for an event, concert festival, or a mountain top for remote communication needs.
